(19) United States
(12) Patent Application Publication
(10) Pub. No.: US 2009/0169100 A1
(43) Pub. Date: Jul. 2, 2009

(54) MOTION-ORIENTED IMAGE COMPENSATING METHOD

(75) Inventor: Shang-Kai Chiu, Hsinchu City (TW)

Correspondence Address: J C PATENTS, INC., 4 VENTURE, SUITE 250, IRVINE, CA, 92618, US

(73) Assignee: WINBOND ELECTRONICS CORP., Hsinchu (TW)

(21) Appl. No.: 11/966,804

(22) Filed: Dec. 28, 2007

(51) Int. Cl. G06K 9/00

(52) U.S. Cl. 382/166; 382/274

(57) ABSTRACT

A motion-oriented image compensating method is disclosed. The method uses the pixel luminance of a present image data and a last image data to judge the minimum motion vector in X-axis and the minimum motion vector in Y-axis of the present image data, following by conducting luminance compensation of the pixels according to the above-mentioned two minimum motion vectors to advance the sharpness of image edges and thereby the image quality.

### BACKGROUND OF THE INVENTION

1. Field of the Invention

The present invention generally relates to an image compensating method, and more particularly, to a motion-oriented image compensating method.

2. Description of Related Art

It is well known that when a motion object is photographed or taking a picture with a shaking camera, the image captured would get blurred. Even though by using a conventional digital camera equipped with a digital image stabilization (DIS) system where the DIS is employed to stabilize the image sequence by means of moving pixel scheme (i.e. a so-called anti-shake function), the images output from the conventional digital camera are still quite blurred, which largely degrades the image quality.

In 2003, Institute of Electrical and Electronics Engineers (IEEE) held an international conference with a subject title of “Advanced Video and Signal Based Surveillance” in Miami, USA, wherein a paper of “Color-based Video Stabilization for Real-time On-board Object Detection on High-speed Trains” was presented. The authors of the paper provided a motion estimation method by using two 1-D (one dimension) characteristic curves and a motion compensation can be conducted by moving pixels according to the obtained motion vectors. Although the proposed approach is able to effectively stabilize an image sequence, but it fails to compensate the blur portion of an image. FIG. 1 is a block diagram of a conventional digital image stabilization (DIS) system. It can be seen from FIG. 1 that the conventional system functions only to conduct motion compensation on input image data IN by a motion estimation unit 102, a motion compensation unit 104 and an image synthesizing unit 106 provided by the system, so as to obtain output image data OUT.

In fact, back in 1992, in a periodical of IEEE, “Transactions on Consumer Electronics”, a paper of “An Adaptive Motion Decision System for Digital Image Stabilization Based on Edge Pattern Matching” was presented, which uses a scheme of edge pattern matching for deciding local motion vectors (LMVs) and uses field motion vectors (FMVs) for generating accumulated motion vectors (AMVs), followed by moving pixels according to the AMVs. One thing is for sure that the above-mentioned scheme still fails to improve the sharpness of image edges. In addition, the above-mentioned scheme would cause a new problem that a blur image edge caused by taking a picture with trembling hands reduces the accuracy of the LMVs obtained by using the edge pattern matching. FIG. 2 is a block diagram of another conventional digital image stabilization (DIS) system. Referring to FIG. 2, a DIS system 210 includes an LMV-generating unit 212, an FMV-generating unit 214, an AMV-generating unit 216 and an address-generating and digital scalar unit 218. In addition, a field memory 220 would read out addresses from the address-generating and digital scalar unit 218. By using the above-mentioned architecture to conduct motion compensation on the input image data IN, an output image data OUT is obtained.

U.S. Pat. No. 6,173,085 “Edge Enhancement Using Modified Boost Function” (January, 2001) and U.S. Pat. No. 6,259,822 “Edge Enhancement which Reduces the Visibility of False Contours” (July, 2001) both provided by Kodak Co. are focused on advancing the sharpness of image edges, wherein an approach to improve the sharpness commonly adopted at that time is introduced, as shown by FIG. 3. Referring to FIG. 3, the major idea of the approach is that multiplying the luminance of the center pixel by a compensation coefficient of 16, multiplying the luminance of the surrounding pixels by a compensation coefficient of 0 and multiplying the luminance of the most-out pixels by a compensation coefficient of −1, following by summating the above-mentioned compensated luminance so as to thereby improve the sharpness. It is clear from FIG. 3, the compensations of the above-mentioned approach are not based on the motion trajectory of images, therefore, and the approach only provides a very limited effect of improving sharpness and fails to effectively advance image quality.

### SUMMARY OF THE INVENTION

Accordingly, the present invention is directed to a motion-oriented image compensating method, which is suitable for promoting the edge sharpness of an edge containing motion objects and the edge sharpness of an edge photographed by a shaking video camera so as to enhance the image quality.

The present invention is also directed to a motion-oriented image compensating method, which is able to conduct image compensation based on the motion trajectory of images to effectively promote the edge sharpness of an image so as to enhance the image quality.

To achieve the above-mentioned or other objectives, the present invention provides a motion-oriented image compensating method suitable to sharpen the image edges generated by an image data with a resolution of M×N pixels, wherein M and N are natural numbers. The method includes the following steps: first, a luminance difference function in X-axis and a luminance difference function in Y-axis are defined according to the pixel luminance of a present image data and a last image data; next, a minimum motion vector in X-axis and a minimum motion vector in Y-axis of the present image data are respectively extracted according to the luminance difference function in X-axis and the luminance difference function in Y-axis; next, whether or not the luminance difference function in X-axis has a minimal value is judged; next, when the luminance difference function in X-axis has the minimal value, luminance compensation of the pixels is conducted according to the minimum motion vector in X-axis; when the luminance difference function in X-axis does not have a minimal value, luminance compensation of the pixels is skipped and then judge whether or not the luminance difference function in Y-axis has a minimal value; when the luminance difference function in Y-axis has the minimal value, luminance compensation of the pixels is conducted according to the minimum motion vector in Y-axis; and when the luminance difference function in Y-axis does not have a minimal value, luminance compensation of the pixels is not conducted.

Based on the above-mentioned or other objectives, the present invention provides a motion-oriented image compensating method suitable to sharpen the image edges generated by an image data with a resolution of M×N pixels, wherein M and N are natural numbers. The method includes the following steps: first, a luminance difference function in X-axis is defined according to the pixel luminance of a present image data and a last image data; next, a minimum motion vector in X-axis of the present image data is extracted according to the luminance difference function in X-axis; then, whether or not the luminance difference function in X-axis has a minimal value is judged; next, when the luminance difference function in X-axis has the minimal value, luminance compensation of the pixels is conducted according to the minimum motion vector in X-axis; when the luminance difference function in X-axis does not have a minimal value, the luminance compensation of the pixels is not conducted. Similar to the above-mentioned method, the luminance compensation is conducted after extracting a minimum motion vector in Y-axis.

The present invention uses the pixel luminance of the present image data and the last image data to extract the minimum motion vector in X-axis of the present image data (horizontal motion vector) and the minimum motion vector in Y-axis of the present image data (vertical motion vector) and then conducts luminance compensation of pixels according to the above-mentioned two minimum motion vectors so as to promote the sharpness of image edges. In other words, the present invention conducts image compensation according to the motion trajectory of an image; thus, regardless an image containing a moving object, or an image photographed by a shaking video camera, the sharpness of image edges and the image quality are able to be effectively promoted by using the method of the present invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional digital image stabilization (DIS) system.

FIG. 2 is a block diagram of another conventional digital image stabilization (DIS) system.

FIG. 3 is a diagram shown the conventional scheme to improve image sharpness.

FIG. 4 is a flowchart of a motion-oriented image compensating method according to an embodiment of the present invention.

FIG. 5 is a flowchart of a motion-oriented image compensating method according to another embodiment of the present invention.

FIG. 6 is a flowchart of a motion-oriented image compensating method according to yet another embodiment of the present invention.

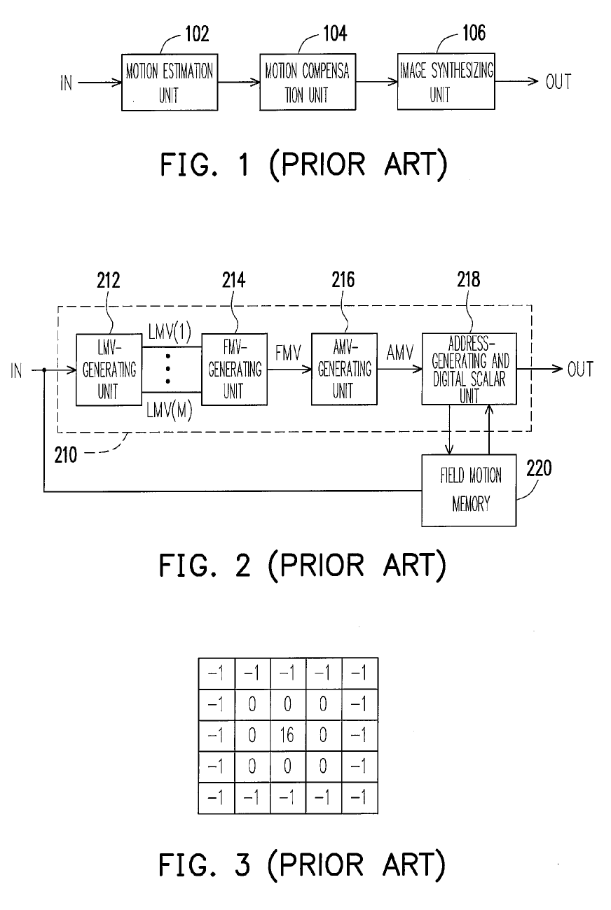

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following, a motion-oriented image compensating method is described, which is suitable to sharpen the image edges generated by an image data with a resolution of M×N pixels, wherein M and N are natural numbers. In order to calculate global motion vectors (including horizontal motion vector and vertical motion vector) between the present frame and the last frame available for further conducting image compensation, a motion estimation approach must be introduced first. A DIS system then would shift the pixels of the present image to stabilize the image sequence. In addition, to obtain instant global motion vectors, a color-based motion estimation scheme employed. In the following, the image data to be processed are assumed to have a resolution of M×N pixels.

First, a luminance characteristic function in X-axis and a luminance characteristic function in Y-axis are respectively defined by the equations (1) and (2):

$$\begin{matrix}{C}_{x} ( j ) = \frac{1}{m} {\sum }_{i = 1}^{m} {r}_{ij} & ( 1 ) \\ {C}_{y} ( i ) = \frac{1}{n} {\sum }_{j = 1}^{n} {r}_{ij} & ( 2 )\end{matrix}$$

wherein rᵢⱼ represents the luminance of the pixel of the i-th row and the j-th column. It can be seen from the equation (1) that the luminance characteristic function in X-axis is able to represent the average luminance of pixels of each column; similarly from the equation (2), the luminance characteristic function in Y-axis is able to represent the average luminance of pixels of each row.

Next, the luminance characteristic function in X-axis and the motion vector in X-axis both of the present image data and the luminance characteristic function in X-axis of the last image data are used to define a luminance difference function in X-axis, wherein the above-mentioned motion vector in X-axis serves as a variable of the luminance difference function in X-axis, as shown by the equation (3) in the following:

$${O}_{x} ( {k}_{x} ) = {\sum }_{j = 1}^{n} \vert {C}_{x} ( {k}_{x} - j ) - {C}_{x - 1} ( j ) \vert \qquad ( 3 )$$

wherein Cₓ, kₓ and Cₓ₋₁ respectively represent the luminance characteristic function in X-axis and the motion vector in X-axis of the present image data and the luminance characteristic function in X-axis of the last image data, and j represents a column number and is a natural number.

Similarly, the luminance characteristic function in Y-axis and the motion vector in Y-axis both of the present image data and the luminance characteristic function in Y-axis of the last image data are used to define a luminance difference function in Y-axis, wherein the above-mentioned motion vector in Y-axis serves as a variable of the luminance difference function in Y-axis, as shown by the equation (4) in the following:

$${O}_{y} ( {k}_{y} ) = {\sum }_{i = 1}^{m} \vert {C}_{y} ( {k}_{y} - i ) - {C}_{y - 1} ( i ) \vert \qquad ( 4 )$$

wherein C_{y}, k_{y} and C_{y-1} respectively represent the luminance characteristic function in Y-axis and the motion vector in Y-axis of the present image data and the luminance characteristic function in Y-axis of the last image data, and i represents a row number and is a natural number.

In this way, the minimal value of the luminance difference function in X-axis can be obtained through applying different values to the motion vector in X-axis kₓ of the equation (3). The motion vector in X-axis kₓ corresponding to the minimal value of the luminance difference function in X-axis is just the horizontal motion vector of the present image and termed as the minimum motion vector in X-axis k_{x,min}. Similarly, the minimal value of the luminance difference function in Y-axis can be obtained through applying different values to the motion vector in Y-axis k_{y} of the equation (4). The motion vector in Y-axis k_{y} corresponding to the minimal value of the luminance difference function in Y-axis is just the vertical motion vector of the present image and termed as the minimum motion vector in Y-axis k_{y,min}. The above-mentioned global motion vector is composed of the minimum motion vector in X-axis k_{x,min} and the minimum motion vector in Y-axis k_{y,min}.

A motion trajectory of an image can be divided into four patterns in terms of horizontal direction and vertical direction. In terms of horizontal direction, a motion trajectory is divided into four patterns, i.e., right-shift pattern, left-shift pattern, left-right bi-direction pattern and static pattern; in terms of vertical direction, a motion trajectory is divided into four patterns, i.e., up-shift pattern, down-shift pattern, up-down bi-direction pattern and static pattern. However, prior to conducting image compensation according to a motion trajectory, it needs to judge whether or not the image is blur already and requires being compensated; to get the answer, it accordingly needs to judge whether or not the luminance difference function in X-axis and the luminance difference function in Y-axis respectively have a minimal value.

For judging whether or not the luminance difference function in X-axis and the luminance difference function in Y-axis respectively have a minimal value, there are different ways depending on the practical needs, wherein a simple way is to judge whether or not the variation of the value of the luminance difference function in X-axis is greater than or equal to a first threshold; if yes, the luminance difference function in X-axis has a minimal value; if no, the luminance difference function in X-axis has no minimal value. Similarly, by judging whether or not the variation of the value of the luminance difference function in Y-axis is greater than or equal to a second threshold, we can decide whether or not the luminance difference function in Y-axis has a minimal value, wherein if yes, the luminance difference function in Y-axis has a minimal value; if no, the luminance difference function in Y-axis has no minimal value.

When the luminance difference function in X-axis has a minimal value, the image is in horizontal motion and needs to conduct luminance compensation on the pixels of the image according to the minimum motion vector in X-axis; otherwise, when the luminance difference function in X-axis has no minimal value, the image is not in horizontal motion and no luminance compensation on the pixels of the image in the horizontal direction is required. Similarly, when the luminance difference function in Y-axis has a minimal value, the image is in vertical motion and needs to conduct luminance compensation on the pixels of the image according to the minimum motion vector in Y-axis; otherwise, when the luminance difference function in Y-axis has no minimal value, the image is not in vertical motion and no luminance compensation on the pixels of the image in the vertical direction is required.

Assuming a luminance compensation on the pixels of the image by using the minimum motion vector in X-axis is required, first, we need to judge which one of three cases the value of the minimum motion vector in X-axis falls in: positive value, negative value or both a positive minimal value and a negative minimal value. Next, when the value of the minimum motion vector in X-axis is positive, it means the image is right-shifted, and accordingly, a luminance compensation of the pixels is conducted by using the following equation (5):

P′ᵢⱼ=Pᵢⱼ+A(B×Pᵢⱼ−C×Pᵢ₍ⱼ₊₁₎−D×Pᵢ₍ⱼ₊₂₎) (5)

wherein P′ᵢⱼ represents the compensated luminance of the pixel of the i-th row and the j-th column, Pᵢⱼ represents the luminance of the pixel of the i-th row and the j-th column, Pᵢ₍ⱼ₊₁₎ represents the luminance of the pixel of the i-th row and the (j+1)-th column, Pᵢ₍ⱼ₊₂₎ represents the luminance of the pixel of the i-th row and the (j+2)-th column, and A, B, C, D and E represent compensation coefficients greater than zero and E>B>C>D≧A. When the value of the minimum motion vector in X-axis is negative, it means the image is left-shifted, and accordingly, a luminance compensation of the pixels is conducted by using the following equation (6):

P′ᵢⱼ=Pᵢⱼ+A(B×Pᵢⱼ−C×Pᵢ₍ⱼ₋₁₎−D×Pᵢ₍ⱼ₋₂₎) (6)

wherein Pᵢ₍ⱼ₋₁₎ represents the luminance of the pixel of the i-th row and the (j−1)-th column, Pᵢ₍ⱼ₋₂₎ represents the luminance of the pixel of the i-th row and the (j−2)-th column. When the values of the minimum motion vector in X-axis have a positive minimal value and a negative minimal value, it means the image is left-right trembled, and accordingly, a luminance compensation of the pixels is conducted by using the following equation (7):

P′ᵢⱼ=Pᵢⱼ+A(E×Pᵢⱼ−C×Pᵢ₍ⱼ₋₁₎−C×Pᵢ₍ⱼ₊₁₎−D×Pᵢ₍ⱼ₋₂₎−D×Pᵢ₍ⱼ₊₂₎) (7)

The value of the above-mentioned compensation coefficient A is less than or equal to 1, wherein greater the value of the compensation coefficient, the image edges are more sharp. In addition, according to experimental results in this regards, in order to produce an optimal sharpening effect of image edges, the above-mentioned compensation coefficients are preferably: B=C+D and E=2C+2D. For example, the above-mentioned compensation coefficients A, B, C, D and E are respectively 0.25, 3, 2, 1 and 6 for the optimal sharpening effect of image edges.

Similarly, assuming a luminance compensation on the pixels of the image by using the minimum motion vector in Y-axis is required, first, we need to judge which one of three cases the value of the minimum motion vector in Y-axis falls in: positive value, negative value or both a positive minimal value and a negative minimal value. Next, when the value of the minimum motion vector in Y-axis is positive, it means the image is up-shifted, and accordingly, a luminance compensation of the pixels is conducted by using the following equation (8):

P′ᵢⱼ=Pᵢⱼ+A(B×Pᵢⱼ−C×P₍ᵢ₊₁₎ⱼ−D×P₍ᵢ₊₂₎ⱼ) (8)

wherein P₍ᵢ₊₁₎ⱼ represents the luminance of the pixel of the (i+1)-th row and the j-th column, P₍ᵢ₊₂₎ⱼ represents the luminance of the pixel of the (i+2)-th row and the j-th column and A, B, C, D and E represent the above-mentioned compensation coefficients. When the value of the minimum motion vector in Y-axis is negative, it means the image is down-shifted, and accordingly, a luminance compensation of the pixels is conducted by using the following equation (9):

P′ᵢⱼ=Pᵢⱼ+A(B×Pᵢⱼ−C×P₍ᵢ₋₁₎ⱼ−D×P₍ᵢ₋₂₎ⱼ) (9)

wherein P₍ᵢ₋₁₎ⱼ represents the luminance of the pixel of the (i−1)-th row and the j-th column, P₍ᵢ₋₂₎ⱼ represents the luminance of the pixel of the (i−2)-th row and the j-th column. When the values of the minimum motion vector in Y-axis have a positive minimal value and a negative minimal value, it means the image is up-down trembled, and accordingly, a luminance compensation of the pixels is conducted by using the following equation (10):

P′ᵢⱼ=Pᵢⱼ+A(E×Pᵢⱼ−C×P₍ᵢ₋₁₎ⱼ−C×P₍ᵢ₊₁₎ⱼ−D×P₍ᵢ₋₂₎ⱼ−D×P₍ᵢ₊₂₎ⱼ) (10)

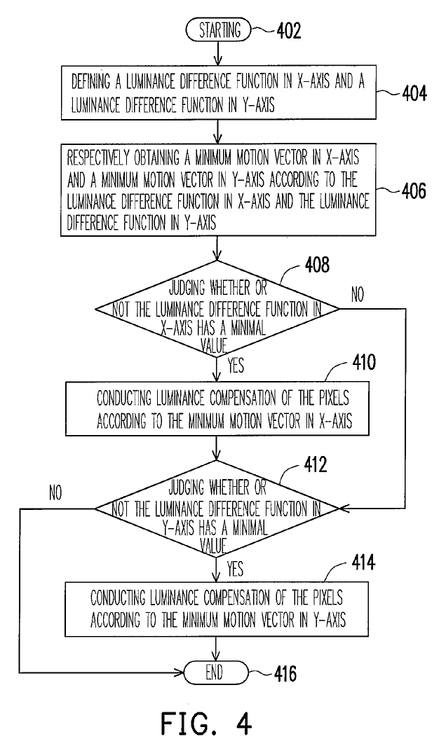

According to the above-mentioned embodiment, the basic operation steps of a motion-oriented image compensating method can be summarized as shown by FIG. 4. FIG. 4 is a flowchart of a motion-oriented image compensating method according to an embodiment of the present invention. The method includes the following steps: first, a flow procedure of conducting image compensation is started (step 402); next, a luminance difference function in X-axis and a luminance difference function in Y-axis are defined according to the pixel luminance of the present image data and the last present image data (step 404); then, a minimum motion vector in X-axis and a minimum motion vector in Y-axis of the present image data are respectively obtained according to the luminance difference function in X-axis and the luminance difference function in Y-axis (step 406). Next, whether or not the luminance difference function in X-axis has a minimal value (step 408) is judged; next, when the luminance difference function in X-axis has a minimal value, luminance compensation of the pixels is conducted according to the minimum motion vector in X-axis (step 410), and whether or not the luminance difference function in Y-axis has a minimal value is continuously judged (step 412). In contrast, when the luminance difference function in X-axis has no minimal value, luminance compensation of the pixels is not conducted, and the procedure directly enters step 412 from step 408; after completing step 412, when the luminance difference function in Y-axis has a minimal value, luminance compensation of the pixels is conducted according to the minimum motion vector in Y-axis (step 414), followed by ending the flow procedure (step 416); in contrast, when the luminance difference function in Y-axis has no minimal value, luminance compensation of the pixels is not conducted and the procedure directly enters step 416 from step 412.

It can be seen from the above description, the major difference between the present invention and the prior art rests in the image compensating method of the present invention is able to conduct luminance compensation of the pixels by using the minimum motion vector in X-axis (horizontal motion vector) and the minimum motion vector in Y-axis (vertical motion vector) of the present image data to sharpen the edges of the image.

In the above-mentioned equations for compensation, the number of pixel within the parentheses can be adjusted according to the real need. For example, corresponding to the three cases of ‘positive value’, ‘negative value’ and ‘both of a positive minimal value and a negative minimal value’ of the minimum motion vector in X-axis, three equations of luminance compensation (11)-(13) are given as follows:

P′ᵢⱼ=Pᵢⱼ+A(B×Pᵢⱼ−C×Pᵢ₍ⱼ₊₁₎) (11)

P′ᵢⱼ=Pᵢⱼ+A(B×Pᵢⱼ−C×Pᵢ₍ⱼ₋₁₎) (12)

P′ᵢⱼ=Pᵢⱼ+A(E×Pᵢⱼ−C×Pᵢ₍ⱼ₋₁₎−C×Pᵢ₍ⱼ₊₁₎) (13)

Similarly, corresponding to the three cases of ‘positive value’, ‘negative value’ and ‘both of a positive minimal value and a negative minimal value’ of the minimum motion vector in Y-axis, three equations of luminance compensation (14)-(16) are given as follows:

P′ᵢⱼ=Pᵢⱼ+A(B×Pᵢⱼ−C×P₍ᵢ₊₁₎ⱼ) (14)

P′ᵢⱼ=Pᵢⱼ+A(B×Pᵢⱼ−C×P₍ᵢ₋₁₎ⱼ) (15)

P′ᵢⱼ=Pᵢⱼ+A(E×Pᵢⱼ−C×P₍ᵢ₋₁₎ⱼ−C×P₍ᵢ₊₁₎ⱼ) (16)

One more example, corresponding to the three cases of ‘positive value’, ‘negative value’ and ‘both of a positive minimal value and a negative minimal value’ of the minimum motion vector in X-axis, another three equations of luminance compensation (17)-(19) are given as follows:

P′ᵢⱼ=Pᵢⱼ+A(B×Pᵢⱼ−C×Pᵢ₍ⱼ₊₁₎−D×Pᵢ₍ⱼ₊₂₎−D×Pᵢ₍ⱼ₊₃₎) (17)

P′ᵢⱼ=Pᵢⱼ+A(B×Pᵢⱼ−C×Pᵢ₍ⱼ₋₁₎−D×Pᵢ₍ⱼ₋₂₎−D×Pᵢ₍ⱼ₋₃₎) (18)

P′ᵢⱼ=Pᵢⱼ+A(E×Pᵢⱼ−C×Pᵢ₍ⱼ₋₁₎−C×Pᵢ₍ⱼ₊₁₎−D×Pᵢ₍ⱼ₋₂₎−D×Pᵢ₍ⱼ₊₂₎−D×Pᵢ₍ⱼ₋₃₎−D×Pᵢ₍ⱼ₊₃₎) (19)

wherein Pᵢ₍ⱼ₊₃₎ represents the luminance of the pixel of the i-th row and the (j+3)-th column, and Pᵢ₍ⱼ₋₃₎ represents the luminance of the pixel of the i-th row and the (j−3)-th column. Similarly, corresponding to the three cases of ‘positive value’, ‘negative value’ and ‘both of a positive minimal value and a negative minimal value’ of the minimum motion vector in Y-axis, three equations of luminance compensation (20)-(22) are given as follows:

P′ᵢⱼ=Pᵢⱼ+A(B×Pᵢⱼ−C×P₍ᵢ₊₁₎ⱼ−D×P₍ᵢ₊₂₎ⱼ−D×P₍ᵢ₊₃₎ⱼ) (20)

P′ᵢⱼ=Pᵢⱼ+A(B×Pᵢⱼ−C×P₍ᵢ₋₁₎ⱼ−D×P₍ᵢ₋₂₎ⱼ−D×P₍ᵢ₋₃₎ⱼ) (21)

P′ᵢⱼ=Pᵢⱼ+A(E×Pᵢⱼ−C×P₍ᵢ₋₁₎ⱼ−C×P₍ᵢ₊₁₎ⱼ−D×P₍ᵢ₋₂₎ⱼ−D×P₍ᵢ₊₂₎ⱼ−D×P₍ᵢ₋₃₎ⱼ−D×P₍ᵢ₊₃₎ⱼ) (22)

wherein P₍ᵢ₊₃₎ⱼ represents the luminance of the pixel of the (i+3)-th row and the j-th column, and P₍ᵢ₋₃₎ⱼ represents the luminance of the pixel of the (i−3)-th row and the j-th column.

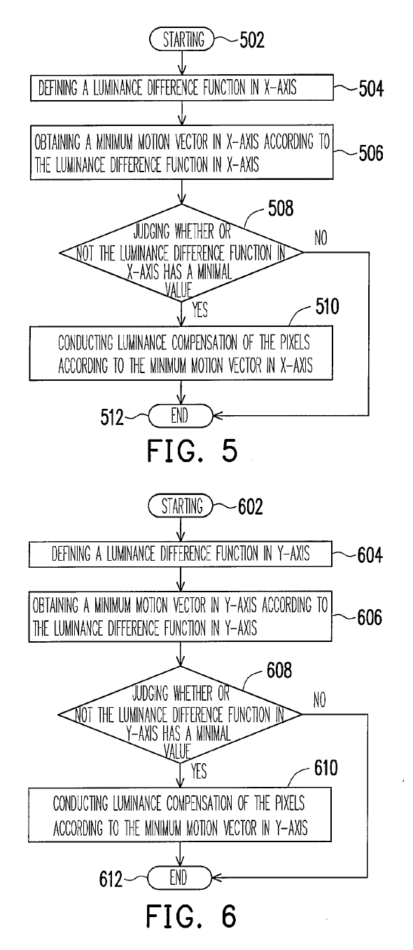

In some specific applications, it is allowed to conduct the compensation by using the horizontal shift or the vertical shift only; thus, an image compensating method by using the horizontal shift can be deducted according to the above-mentioned compensation flow procedure, as shown by FIG. 5. FIG. 5 is a flowchart of an image compensating method according to another embodiment of the present invention. The method of FIG. 5 includes following steps. First, a flow procedure of conducting image compensation is started (step 502). Next, a luminance difference function in X-axis is defined according to the pixel luminance of the present image data and the last present image data (step 504). Next, a minimum motion vector in X-axis is obtained according to the luminance difference function in X-axis of the present image data (step 506). Next, whether or not the luminance difference function in X-axis has a minimal value is judged (step 508). When the luminance difference function in X-axis has a minimal value, luminance compensation of the pixels is conducted according to the minimum motion vector in X-axis (step 510), after that, the flow procedure of conducting luminance compensation of the pixels is ended (step 512). In contrast, when the luminance difference function in X-axis has no minimal value, luminance compensation of the pixels is not conducted and the procedure directly enters step 512 from step 508.

Similarly, an image compensating method by using the vertical shift can be deducted, as shown by FIG. 6. FIG. 6 is a flowchart of an image compensating method according to yet another embodiment of the present invention. The method of FIG. 6 includes the following steps. First, a flow procedure of conducting image compensation is started (step 602). Next, a luminance difference function in Y-axis is defined according to the pixel luminance of the present image data and the last present image data (step 604). Next, a minimum motion vector in Y-axis is obtained according to the luminance difference function in Y-axis of the present image data (step 606). Next, whether or not the luminance difference function in Y-axis has a minimal value is judged (step 608). When the luminance difference function in Y-axis has a minimal value, luminance compensation of the pixels according to the minimum motion vector in Y-axis is conducted (step 610), after that, the flow procedure of conducting luminance compensation of the pixels is ended (step 612). In contrast, when the luminance difference function in Y-axis has no minimal value, luminance compensation of the pixels is not conducted and the procedure directly enters step 612 from step 608.

According to the above-mentioned motion-oriented image compensating method, anyone skilled in the art would be capable of implementing a plurality of DIS systems. Note that the above-mentioned scheme of luminance compensation of the pixels can either focus on at least one of tri-primary color signals (R signal, G signal and B signal) or on at least one of luminance signal (Y signal) and two color difference signals (Cb signal and Cr signal). In general, if a compensation focuses on one of the tri-primary color signals, then, the compensation focusing on the green signal is preferred, because human eyes have a more sensitive response on green light. On the other hand, in terms of Y-Cb-Cr color signal format, the compensation on the Y signal is more ideal. In addition, the video camera the present invention is applicable to can be digital camera, digital video camera or monitor.

In summary, the present invention uses the present image data and the last present image to obtain the minimum motion vector in X-axis (horizontal motion vector) and the minimum motion vector in Y-axis (vertical motion vector) of the present image data, followed by conducting luminance compensation of the pixels according to the above-mentioned two minimum motion vectors so as to promote the sharpness of image edges. In other words, the present invention conducts image compensation based on the motion trajectory of the image. In this way, regardless an image containing a moving object or an image taken by a shaking video camera, the sharpness of image edges and the image quality can be effectively promoted by the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A motion-oriented image compensating method, suitable for sharpening the image edges displayed by an image data with a resolution of M×N pixels, wherein M and N are natural numbers; the method comprising:
defining a luminance difference function in X-axis and a luminance difference function in Y-axis according to a pixel luminance of a present image data and a last image data;
respectively extracting a minimum motion vector in X-axis and a minimum motion vector in Y-axis of the present image data according to the luminance difference function in X-axis and the luminance difference function in Y-axis;
judging whether or not the luminance difference function in X-axis has a minimal value;
wherein when the luminance difference function in X-axis has the minimal value, a luminance compensation of the pixels is conducted according to the minimum motion vector in X-axis;
wherein when the luminance difference function in X-axis does not have a minimal value, the luminance compensation of the pixels is not conducted;
judging whether or not the luminance difference function in Y-axis has a minimal value;
wherein when the luminance difference function in Y-axis has the minimal value, the luminance compensation of the pixels is conducted according to the minimum motion vector in Y-axis; and
wherein when the luminance difference function in Y-axis does not have a minimal value, the luminance compensation of the pixels is not conducted.

2. A motion-oriented image compensating method, suitable for sharpening the image edges displayed by an image data with a resolution of M×N pixels, wherein M and N are natural numbers; the method comprising:
defining a luminance difference function in X-axis according to a pixel luminance of a present image data and a last image data;
extracting a minimum motion vector in X-axis of the present image data according to the luminance difference function in X-axis;
judging whether or not the luminance difference function in X-axis has a minimal value;
wherein when the luminance difference function in X-axis has the minimal value, a luminance compensation of the pixels is conducted according to the minimum motion vector in X-axis; and
wherein when the luminance difference function in X-axis does not have a minimal value, the luminance compensation of the pixels is not conducted.

3. The motion-oriented image compensating method according to claim 2, wherein the step of defining the luminance difference function in X-axis comprises:
defining a luminance characteristic function in X-axis capable of representing the average luminance of the pixels of each column; and
defining the luminance difference function in X-axis by using the luminance characteristic function in X-axis and motion vector in X-axis of the present image data and the luminance characteristic function in X-axis of the last image data, wherein the motion vector in X-axis serves as a variable of the luminance difference function in X-axis.

4. The motion-oriented image compensating method according to claim 2, wherein the step of conducting luminance compensation of the pixels according to the minimum motion vector in X-axis comprises:
judging which one of three cases the value of the minimum motion vector in X-axis falls in: positive value, negative value or both a positive minimal value and a negative minimal value;
conducting luminance compensation of the pixels according to P′ᵢⱼ=Pᵢⱼ+A(B×Pᵢⱼ−C×Pᵢ₍ⱼ₊₁₎) when the value of the minimum motion vector in X-axis is positive;
conducting luminance compensation of the pixels according to P′ᵢⱼ=Pᵢⱼ+A(B×Pᵢⱼ−C×Pᵢ₍ⱼ₋₁₎) when the value of the minimum motion vector in X-axis is negative; and
conducting luminance compensation of the pixels according to P′ᵢⱼ=Pᵢⱼ+A(E×Pᵢⱼ−C×Pᵢ₍ⱼ₋₁₎−C×Pᵢ₍ⱼ₊₁₎) when the values of the minimum motion vector in X-axis have a positive minimal value and a negative minimal value,
wherein P′ᵢⱼ represents the compensated luminance of the pixel of the i-th row and the j-th column, represents the luminance of the pixel of the i-th row and the j-th column, Pᵢ₍ⱼ₊₁₎ represents the luminance of the pixel of the i-th row and the (j+1)-th column, Pᵢ₍ⱼ₊₁₎ represents the luminance of the pixel of the i-th row and the (j−1)-th column, and A, B, C, and E represent compensation coefficients greater than zero and E>B>C>A.

5. The motion-oriented image compensating method according to claim 2, wherein the step of conducting luminance compensation of the pixels according to the minimum motion vector in X-axis comprises:
judging which one of three cases the value of the minimum motion vector in X-axis falls in: positive value, negative value or both a positive minimal value and a negative minimal value;
conducting luminance compensation of the pixels according to P′ᵢⱼ=Pᵢⱼ+A(B×Pᵢⱼ−C×Pᵢ₍ⱼ₊₁₎−D×Pᵢ₍ⱼ₊₂₎) when the value of the minimum motion vector in X-axis is positive;
conducting luminance compensation of the pixels according to P′ᵢⱼ=Pᵢⱼ+A(B×Pᵢⱼ−C×Pᵢ₍ⱼ₋₁₎−D×Pᵢ₍ⱼ₋₂₎) when the value of the minimum motion vector in X-axis is negative; and
conducting luminance compensation of the pixels according to P′ᵢⱼ=Pᵢⱼ+A(E×Pᵢⱼ−C×Pᵢ₍ⱼ₋₁₎−C×Pᵢ₍ⱼ₊₁₎−D×Pᵢ₍ⱼ₋₂₎−D×Pᵢ₍ⱼ₊₂₎) when the values of the minimum motion vector in X-axis have a positive minimal value and a negative minimal value,
wherein P′ᵢⱼ represents the compensated luminance of the pixel of the i-th row and the j-th column, Pᵢⱼ represents the luminance of the pixel of the i-th row and the j-th column, Pᵢ₍ⱼ₊₁₎ represents the luminance of the pixel of the i-th row and the (j+1)-th column, Pᵢ₍ⱼ₋₁₎ represents the luminance of the pixel of the i-th row and the (j−1)-th column, Pᵢ₍ⱼ₊₂₎ represents the luminance of the pixel of the i-th row and the (j+2)-th column, Pᵢ₍ⱼ₋₂₎ represents the luminance of the pixel of the i-th row and the (j−2)-th column and A, B, C, D and E represent compensation coefficients greater than zero and E>B>C>D≧A.

6. The motion-oriented image compensating method according to claim 2, wherein the scheme of conducting luminance compensation of the pixels comprises conducting luminance compensation on at least one of red signal R, green signal G and blue signal B.

7. A motion-oriented image compensating method, suitable for sharpening the image edges displayed by an image data with a resolution of M×N pixels, wherein M and N are natural numbers; the method comprising:
defining a luminance difference function in Y-axis according to a pixel luminance of a present image data and a last image data;
extracting a minimum motion vector in Y-axis of the present image data according to the luminance difference function in Y-axis;
judging whether or not the luminance difference function in Y-axis has a minimal value;
conducting luminance compensation of the pixels according to the minimum motion vector in Y-axis when the luminance difference function in Y-axis has the minimal value; and
not conducting luminance compensation of the pixels when the luminance difference function in Y-axis does not have a minimal value.

8. The motion-oriented image compensating method according to claim 7, wherein the step of defining the luminance difference function in Y-axis comprises:
defining a luminance characteristic function in Y-axis capable of representing the average luminance of the pixels of each row; and
defining the luminance difference function in Y-axis by using the luminance characteristic function in Y-axis and motion vector in Y-axis of the present image data and the luminance characteristic function in Y-axis of the last image data, wherein the motion vector in Y-axis is served as a variable of the luminance difference function in Y-axis.

9. The motion-oriented image compensating method according to claim 7, wherein the step of conducting luminance compensation of the pixels according to the minimum motion vector in Y-axis comprises:
judging which one of three cases the value of the minimum motion vector in Y-axis falls in: positive value, negative value or both a positive minimal value and a negative minimal value;
conducting luminance compensation of the pixels according to P′ᵢⱼ=Pᵢⱼ+A(B×Pᵢⱼ−C×P₍ᵢ₊₁₎ⱼ) when the value of the minimum motion vector in Y-axis is positive;
conducting luminance compensation of the pixels according to P′ᵢⱼ=Pᵢⱼ+A(B×Pᵢⱼ−C×P₍ᵢ₋₁₎ⱼ) when the value of the minimum motion vector in Y-axis is negative; and
conducting luminance compensation of the pixels according to P′ᵢⱼ=Pᵢⱼ+A(E×Pᵢⱼ−C×P₍ᵢ₋₁₎ⱼ−C×P₍ᵢ₊₁₎ⱼ) when the values of the minimum motion vector in Y-axis have a positive minimal value and a negative minimal value,
wherein P′ᵢⱼ represents the compensated luminance of the pixel of the i-th row and the j-th column, Pᵢⱼ represents the luminance of the pixel of the i-th row and the j-th column, P₍ᵢ₊₁₎ⱼ represents the luminance of the pixel of the (i+1)-th row and the j-th column, P₍ᵢ₋₁₎ⱼ represents the luminance of the pixel of the (i−1)-th row and the j-th column and A, B, C, and E represent compensation coefficients greater than zero and E>B>C>A.

10. The motion-oriented image compensating method according to claim 7, wherein the step of conducting luminance compensation of the pixels according to the minimum motion vector in Y-axis comprises:
judging which one of three cases the value of the minimum motion vector in Y-axis falls in: positive value, negative value or both a positive minimal value and a negative minimal value;
conducting luminance compensation of the pixels according to P′ᵢⱼ=Pᵢⱼ#+A(B×Pᵢⱼ−C×P₍ᵢ₊₁₎ⱼ−D×P₍ᵢ₊₂₎ⱼ) when the value of the minimum motion vector in Y-axis is positive;
conducting luminance compensation of the pixels according to P′ᵢⱼ=Pᵢⱼ+A(B×Pᵢⱼ−C×P₍ᵢ₋₁₎ⱼ−D×P₍ᵢ₋₂₎ⱼ) when the value of the minimum motion vector in Y-axis is negative; and
conducting luminance compensation of the pixels according to P′ᵢⱼ=Pᵢⱼ+A(E×Pᵢⱼ−C×P₍ᵢ₋₁₎ⱼ−C×P₍ᵢ₊₁₎ⱼ−D×P₍ᵢ₋₂₎ⱼ−D×P₍ᵢ₊₂₎ⱼ) when the values of the minimum motion vector in Y-axis have a positive minimal value and a negative minimal value,
wherein P′ᵢⱼ represents the compensated luminance of the pixel of the i-th row and the j-th column, Pᵢⱼ represents the luminance of the pixel of the i-th row and the j-th column, P₍ᵢ₊₁₎ⱼ represents the luminance of the pixel of the (i+1)-th row and the j-th column, P₍ᵢ₋₁₎ⱼ represents the luminance of the pixel of the (i−1)-th row and the j-th column, P₍ᵢ₊₂₎ⱼ represents the luminance of the pixel of the (i+2)-th row and the j-th column, P₍ᵢ₋₂₎ⱼ represents the luminance of the pixel of the (i−2)-th row and the j-th column and A, B, C, D and E represent compensation coefficients greater than zero and E>B>C>D≧A.

11. The motion-oriented image compensating method according to claim 7, wherein the step of conducting luminance compensation of the pixels comprises conducting luminance compensation on at least one of red signal R, green signal G and blue signal B.
